(19) United States
(12) Patent Application Publication
(10) Pub. No.: US 2025/0109777 A1
(43) Pub. Date: Apr. 3, 2025

(54) ASSEMBLY HAVING AN ELASTOMER BODY

(71) Applicant: Vibracoustic SE, Darmstadt (DE)

(72) Inventors: Stefan Furlan, Ehrenkirchen (DE); Niklas Müller, Ihringen (DE); Leon Müller, Bantzenheim (FR); Markus Dürre, Neuenburg am Rhein (DE)

(21) Appl. No.: 18/834,840

(22) PCT Filed: Jan. 1, 2023
(86) PCT No.: PCT/EP2023/050003

§ 371 Date: Jul. 31, 2024

(30) Foreign Application Priority Data
Feb. 1, 2022 (DE) 10 2022 102 371.0

(51) Int. Cl. F16F 1/373

(52) U.S. Cl. CPC F16F 1/3732; F16F 2226/04; F16F 2228/08; F16F 2230/0005; F16F 2230/007

(57) ABSTRACT

An assembly includes a first component having an opening with an inner circumferential surface; a clamping device through which a central longitudinal axis passes, and which comprises an inner sleeve with a bore for fastening the damping device to a second component; and an elastomer body for fastening the damping device to the first component. In embodiments, the elastomer body surrounds the outer circumference of the inner sleeve, the elastomer body supports itself in a pretensioned manner against the inner circumferential surface, and the damping device does not include an outer sleeve.

### CROSS-REFERENCE TO RELATED APPLICATIONS

This application is a National Stage Patent Application of and claims priority to International Patent Application No. PCT/EP2023/050003, filed on Jan. 1, 2023, and German Patent Application No. DE 10 2022 102 371.0, filed on Feb. 1, 2022, the contents of both of which are hereby incorporated by reference in their entirety.

### TECHNICAL FIELD

The invention relates to an assembly with an elastomer body.

### BACKGROUND

It is known from practice for a component to be mounted elastically on a further component by means of a spring device. To dampen vibrations, the spring device is fixed in an opening of one of the components, and the other component is then connected to the spring device.

Assemblies of the type mentioned above are used in motor vehicle construction in order to reduce the vibration transmitted during travel or even at a standstill from one component, for example an engine or a compressor, to another component, for example a vehicle part, and thereby increase driving comfort.

However, a disadvantage of this is that vulcanization tools have to be constructed that are sometimes complex and of multi-part design in order to be able to demold complex geometries of the spring device and/or in order to allow many insert parts in the vulcanization tool. Such insert parts, for example an outer sleeve of an elastomer bushing, are also problematic as regards tolerances for a subsequent press fit with a component and safe operation. On the other hand, sleeve-free spring devices do not provide satisfactory safety against disengagement from the opening.

### SUMMARY

An object of the present invention is to provide an assembly which permits improved and at the same time cost-effective production and assembly while at the same time improving and securing the fit of a damping device during operation.

Aspects and features of the invention are disclosed herein.

According to aspects and teachings of the invention, an assembly is described comprising a first component having an opening with an inner circumferential surface, and
a damping device through which a central longitudinal axis passes and which comprises an inner sleeve with a bore designed for fastening the damping device to a further component, and an elastomer body for fastening the damping device to the first component, which elastomer body surrounds the outer circumference of the inner sleeve and supports itself in a pretensioned manner against the inner circumferential surface, wherein the damping device is designed without an outer sleeve—the outer circumferential surface can as it were be formed by the elastomer body, preferably in the regions of contact with the first component, more preferably completely.

According to aspects and teachings of the invention, the damping device can already be produced more cost-effectively by virtue of the fact that an outer sleeve is omitted and the elastomer body now bears directly (without an intermediate outer sleeve) against the inner circumferential surface. As a result, a vulcanization tool is designed that is of less complexity, since now only an inner sleeve is inserted there. Overall, the invention reduces the complexity of the vulcanization tool in the manufacturing process. In addition, the omission of an outer sleeve eliminates the need to adhere to tight tolerances for the connection to the first component, for example by means of a press fit. By virtue of the fact that the elastomer body bears against the first component, its deformability serves to compensate for tolerance. In addition, it is no longer necessary to ensure reliable pressing of an outer sleeve and to monitor the corresponding assembly process. The omission of an outer sleeve leads to an at least in part elastomeric circumferential region of the elastomer body, as a result of which stiffness ratios in the axial and/or radial direction can be easily adjusted. The damping device can be rotationally symmetrical with respect to the central longitudinal axis.

The opening can be a through-opening, the damping device advantageously being able to be attached to a respective component from both sides of the through-opening. The opening can alternatively be a blind hole, in which case a continuous or deep opening can be omitted, if the first component does not allow it. The opening can be a bore.

The damping device can be inserted or pressed into the opening along an insertion direction, whereby a press fit is formed in the second case. The damping device or its elastomer body can have a dimensional overlap, preferably in the radial direction, with respect to the opening, which leads to pretensioning and ensures a firm fit of the damping device in the opening and at the same time provides a tolerance compensation with respect to the first component. For this purpose, for example, the elastomer body can at least in part have a diameter which is larger than the diameter of the opening in the respective contact region in the assembly state between the first component and the damping device. It is precisely this press fit that permits constructive configurations of the opening and/or of the elastomer body, whereby both the overall stiffness in the axial and/or radial direction and also a specific coordination between axial and radial damping behavior can be influenced. In this case, the adjustment of the stiffness ratio can be influenced via various approaches, which are the subject of advantageous embodiments.

Finally, the damping device can be used to dampen vibrations and oscillations of a component, for example a compressor.

The assembly state should be understood as the state in which the damping device is finally held in the opening after its installation. The unloaded state should be understood as the state before assembly. Diameter should be understood in the mathematical sense as a chord or length of the chord through a center point of the corresponding body. Relationships between the damping device and the first component are in principle described in the assembly state, unless it is explicitly stated otherwise, for example in the pre-assembly state or unloaded state. An outer sleeve can be a cylindrical sleeve, which is made of plastic or a metal, for example, and usually surrounds the elastomer body about the outer circumference thereof. The direction of insertion is the direction along the central longitudinal axis in which the damping device is inserted into the opening during assembly. Without an outer sleeve means that there is no outer sleeve covering the outer circumference of the elastomer body.

According to a further development of the assembly according to the invention, the opening has a radially inwardly protruding circumferential flange, and the elastomer body has a circumferential groove, wherein the circumferential flange can engage positively in the groove. Preferably, a first longitudinal contact length can be formed along the groove base of the groove and along the circumferential flange. The first longitudinal contact length indicates the distance, in the direction of the central longitudinal axis, over which the first component and the elastomer body bear on each other with contact in this region. The circumferential flange can be an inner circumferential flange; the groove can be an outer circumferential groove. This flange/groove connection ensures that the damping device is fitted securely. The groove can be designed in such a way that it has a groove base and two groove walls adjacent to the latter, such that the flange can be engaged on three sides. Thus, the secure fit can be ensured in two opposite spatial directions along the central longitudinal axis.

According to a conceivable further development of the assembly according to the invention, the opening can comprise adjacent, preferably directly adjacent, to the circumferential flange a cylindrical attachment portion, i.e. a portion of constant diameter. The elastomer body can support itself against this attachment portion. In addition, the opening is configured as simply as possible and yet can still secure the damping device in a reliable manner.

According to a conceivable further development of the assembly according to the invention, the circumferential flange can have at least one attachment surface for the elastomer body, preferably for the groove thereof, wherein the attachment surface can have a conical profile. Seen in longitudinal section, the attachment surface may be tilted in the direction of the central longitudinal axis and in an insertion direction, whereby the attachment surface can enclose an angle with the central longitudinal axis, preferably in the range from 600 up to and including 90°. This can safely prevent disengagement of the damping device in the direction counter to the insertion direction. Preferably, the assembly has only a single insertion direction. In this way, geometries of the opening and/or of the elastomer body can be optimized in terms of their operational functionality, without any possibility of insertion from several directions having a negative effect.

According to a conceivable further development of the assembly according to the invention, the first longitudinal contact length can be in the range of 2 mm to 15 mm. The groove base thus contacts the circumferential flange, in the direction of the central longitudinal axis, over a distance of 2 mm to 15 mm. This range represents an optimum between a sufficient radial stop function (lower limit), in which the elastomer body buffers a radial abutment of inner sleeve and flange in the region of its groove base, and sufficient economy (upper limit), since a first longitudinal contact length of more than 15 mm can only be produced at considerable cost. Of course, in the respective limit regions, the same effects can be achieved beyond the aforementioned limits, but possibly in a weakened form.

According to a conceivable further development of the assembly according to the invention, the elastomer body can have a radially outwardly protruding circumferential projection, which bears on the inner circumferential surface over a second longitudinal contact length of at least 1.5 mm. The circumferential projection thus contacts the inner circumferential surface, in the direction of the central longitudinal axis, over a distance of at least 1.5 mm. It is conceivable that the second longitudinal contact length lies in the region of the cylindrical attachment portion, wherein additional securing is provided besides the flange/groove connection. It is also conceivable that a ratio of the length of the opening in the direction of the central longitudinal axis to the second longitudinal contact length is in the range of 2 to 5, preferably of 2.5 to 3.5. These dimensions serve, among other things, to ensure a secure and permanent fit of the damping device. By way of this second longitudinal contact length, a stiffness ratio of the assembly in the axial and radial direction is also advantageously adjustable. It is conceivable that the second longitudinal contact length is dimensioned in such a way that a stiffness ratio of radial stiffness to axial stiffness lies in the range of 0.6 to 2.4. As the second longitudinal contact length increases, the radial stiffness increases, the axial stiffness remaining unaffected. It is conceivable that the circumferential projection forms a groove wall of the groove and/or bears on the attachment surface of the circumferential flange. This allows a compact elastomer body to be formed. The circumferential projection can be formed integrally with the elastomer body, preferably in one piece and of the same material. It can protrude in the radial direction from a leg of the elastomer body. Of course, the same effects can be achieved in the respective limit regions beyond the aforementioned limits, but possibly in a weakened form.

According to a conceivable further development of the assembly according to the invention, the circumferential projection in the unloaded state can have a square, rectangular or trapezoid longitudinal surface area. These geometries can influence the second longitudinal contact length, wherein a stiffness ratio of the assembly in the axial and radial direction is advantageously adjustable.

According to a conceivable further development of the assembly according to the invention, in the region of the second longitudinal contact length, the elastomer body can bear on the inner circumferential surface continuously in the circumferential direction. As a result, the stiffness ratio can be made independent of the force acting from any radial direction.

According to a conceivable further development of the assembly according to the invention, the ratio between the second longitudinal contact length and the first longitudinal contact length can be greater than 0.75. By way of this ratio, a stiffness ratio of the assembly in the axial and radial direction is advantageously adjustable. As the ratio increases, the radial stiffness increases in relation to the axial stiffness. Of course, the same effect can be achieved in the limit region beyond the aforementioned limit, but possibly in a weakened form.

According to a further development of the assembly according to the invention, a ratio of the diameter of the elastomer body, at the portion designed to bear on the circumferential flange, in the unloaded state of the elastomer body, to the diameter of the circumferential flange or to the largest diameter of the circumferential flange can be greater than 1.03. The here relevant portion of the elastomer body bearing on the circumferential flange can be the groove base. This dimension of at least 3% overlap ensures a secure and permanent fit of the damping device. The diameter of the unloaded groove base can be 3% larger than the diameter of the circumferential flange. Of course, the same effect can be achieved in the limit region beyond the aforementioned limit, but possibly in a weakened form.

According to a further development of the assembly according to the invention, a ratio of the diameter of the elastomer body, in the portion designed to bear on the inner circumferential surface, in particular in the region of the second longitudinal contact length, in the unloaded state of the elastomer body, to the diameter of the opening, which can be a second diameter, or to the largest diameter of the opening is greater than 1.03. This dimension of at least 3% overlap also ensures a secure and permanent fit of the damping device and influences the stiffness ratio of the assembly in the axial and radial directions. As the ratio increases, the radial stiffness also increases. The diameter of the unloaded circumferential projection can be 3% greater than the diameter of the cylindrical attachment portion. Of course, the same effect can be achieved in the limit region beyond the aforementioned limit, but possibly in a weakened form.

According to a further development of the assembly according to the invention, a difference between the second diameter and the first diameter can be greater than 5 mm. This allows a radial shoulder with a radial length of at least 2.5 mm to be realized. This dimension serves, among other things, to ensure a secure and permanent fit of the damping device. Of course, the same effect can be achieved in the limit region beyond the aforementioned limit, but possibly in a weakened form.

According to a further development of the assembly according to the invention, the groove and/or the circumferential projection can have a cross-sectionally circular, oval, elliptic or elongate outer circumferential contour, and/or the circumferential flange and/or the inner circumferential surface and/or an attachment portion of the opening can have a cross-sectionally circular inner circumferential contour. The inner circumferential surface of the opening can preferably be designed in this way at least in the region of the second longitudinal contact length. The flange/groove connection may be non-circular, resulting in different clearance paths and different pretensioning and/or different stiffness in different radial directions. The same applies to the contact region on the inner circumferential surface or to the region of the second longitudinal contact length. In addition, the inner sleeve can thus be arranged movably in the opening, for example in a transverse direction (perpendicular to the central longitudinal axis). This leads to simpler assembly of further components, since the damping device can be easily moved along the respective contour, for example along the elongate-hole-like outer circumferential contour.

It is conceivable that this configuration is provided only on the component side (at least on the circumferential flange and/or the inner circumferential surface of the opening), and the elastomer body is designed with a circular cross section at least in the regions of contact to the first component. Firstly, this can influence the stiffness ratio axially to radially. Secondly, different characteristic curves, in particular with regard to linear spring stiffness, can be made possible by a contour of the circumferential flange and/or inner circumferential surface of the opening that deviates from a circular contour. Thirdly, these advantages can be realized without the elastomer body having to be adapted accordingly; it can thus be or remain circular in cross section at least in the regions of contact to the first component. The provision of new vulcanization tools is therefore avoided.

According to a further development of the assembly according to the invention, the damping device can have at least one radially outwardly protruding axial stop, preferably two radially outwardly protruding axial stops, which is/are preferably arranged at the end side or preferably at opposite end sides of the damping device. The axial stop(s) can preferably be circular in cross section in order to be non-directional. The at least one axial stop can be formed integrally with the elastomer body, preferably in one piece and of the same material. Alternatively, it is conceivable that only one of the two axial stops is formed integrally with the elastomer body, preferably in one piece and of the same material, and the second axial stop adjacent to the elastomer body is connected to the inner sleeve. The at least one axial stop can protrude in the radial direction from a leg or a fold of the elastomer body. Many functions can be associated with the at least one axial stop. It can serve as an axial limit to the travel of the first component and/or of another component and can buffer an axial stop. It is conceivable that the at least one axial stop at least in part covers an axial surface area of the first component. In addition, the at least one axial stop can ensure a secure fit of the damping device and also prevent disengagement from the opening. Since the invention does not require an outer sleeve normally pressed into the opening, a positive fit between the elastomer body and the opening can also lead to a secure fit without an outer sleeve. If the two axial stops are provided, a damping device can be realized with axial stops in both spatial directions along the central longitudinal axis.

According to a conceivable further development of the assembly according to the invention, the at least one axial stop or one of the two axial stops can form a groove wall of the groove. This allows a compact elastomer body to be formed.

According to a conceivable further development of the assembly according to the invention, safety against disengagement can be additionally improved by the fact that a material thickness of the elastomer body in the region surrounding the circumferential flange at least partially corresponds to at least the first longitudinal contact length. The material thickness can be defined perpendicular to the center line of the elastomer body. This material thickness can at least be given in the region of an axial stop bearing on the circumferential flange and a region on the inner circumference of the circumferential flange. The region surrounding the circumferential flange can form the groove. As a result, there is sufficient material thickness there, which opposes a disengaging force.

According to a further development of the assembly according to the invention, the one axial stop or at least one of the axial stops can have mounting slots which extend in the radial direction and which are preferably arranged equidistant from each other with respect to the central longitudinal axis. Preferably, the only axial stop having mounting slots is the one guided through the opening during assembly of the damping device. This allows this axial stop to fold up easily during assembly, in order to avoid substantial stresses and damage, and it thus reduces the necessary assembly force. This axial stop, which can have an umbrella shape, can therefore snap open into its end position after passing through the opening or after being inserted sufficiently far into the opening or can snap out of the opening. The mounting slots can extend over about half of the radial extent of the respective axial stop, resulting in a suitable configuration for easy assembly and for a reliable axial stop function.

According to a conceivable further development of the assembly according to the invention, the one axial stop or at least one of the axial stops and/or the circumferential projection can be designed, preferably designed geometrically, in such a way that, during the assembly of the damping device in the opening, the corresponding axial stop bears on the elastomer body axially below or adjacent to the circumferential projection. Preferably, this applies to the axial stop that is guided through the opening during assembly of the damping device. The elastomer body can form a mounting corner into which the axial stop can be inserted during assembly. The mounting corner can be a step, and/or its radial depth corresponds at least to the material thickness of the inserted axial stop. Firstly, this prevents a radial superposition of axial stop and circumferential projection during assembly, in order to avoid high assembly forces. Secondly, the circumferential projection can successfully prevent the corresponding axial stop from engaging in the circumferential flange during assembly and thus no longer being able to be mounted.

According to a further development of the assembly according to the invention, the one axial stop or at least one of the axial stops can be arranged on the elastomer body, preferably on a fold of the elastomer body, or in the longitudinal direction adjacent to the elastomer body or its fold. The at least one axial stop can be formed integrally with the elastomer body, preferably in one piece and of the same material. Alternatively, it is conceivable that the axial stop is bound to the inner sleeve, preferably vulcanized thereon, adjacent to the elastomer body. Between this axial stop and the elastomer body, a connecting elastomer skin may be present, which may be due to production and can simplify the vulcanization tool. However, it does not lead to a forced coupling of this adjacent axial stop and the elastomer body, i.e. a deformation of one of axial stop and elastomer body does not necessarily lead to a deformation of the other part. It is precisely the adjacent arrangement of the axial stop that makes it possible to use it as an absorption device for high-frequency vibrations. The axial stop can oscillate freely from the elastomer body without affecting the latter. This adjacent axial stop does not have a holding function. The adjacent arrangement of the axial stop also means that there is no relative movement between this axial stop and the elastomer body, thereby avoiding friction wear and flexible eigenforms with dynamic hardening in the elastomer body. The adjacent axial stop can be designed and/or arranged in such a way that it does not bear against the first component in the assembly state, but instead can bear against another (second) component. This arrangement improves the absorption function.

According to a conceivable further development of the assembly according to the invention, at least one of the axial stops can be arranged on the elastomer body in such a way that the center line of the axial stop at the center line of the elastomer body encloses an angle with the central longitudinal axis in the range of 0° to 45°. This means that a snapping apart of the axial stop or its snapping out of the opening into its end position after passing through the opening or after being inserted sufficiently far into the opening can be improved, such that the axial stop experiences pretensioning during insertion, with this increasing as the angle decreases. This effect can be increased when the axial stop is arranged at the fold, since a whip-like pretensioning can thus be generated, which allows the axial stop to snap apart or snap out of the opening.

According to a conceivable further development of the assembly according to the invention, the one axial stop or at least one of the axial stops can be contoured. The contoured axial stop can have a contour on its side facing away from a transverse center plane of the damping device. The contour can be, for example, a circular wave contour, a radial wave contour or a checkerboard-like grid or can be formed by point-like domes. The contoured axial stop can alternatively or additionally have a contour on its circumferential surface. For example, the mounting slots are a contour in this sense. In any case, such contouring serves for a smooth transition between basic stiffness and progression.

According to a conceivable further development of the assembly according to the invention, a radially inner connection point of the one axial stop or of at least one of the axial stops to the inner sleeve, to the elastomer body or to a leg of the elastomer body can lie within the circumferential flange, as viewed in the longitudinal direction. This makes it easier to feed the respective axial stop through the opening during assembly.

According to a further development of the assembly according to the invention, a further component can be provided, which is connectable to the damping device and has a stop surface which can preferably be arranged axially adjacent to the one axial stop or to one of the axial stops, wherein a (first and/or second) longitudinal distance between this axial stop and the stop surface is less than or equal to an overlap distance between this axial stop and the first component. Other components may include, for example, a stop plate and a compressor that is to be damped. Other components can be used in an expedient way in order to prevent disengagement. This embodiment in fact serves to ensure that, after a longitudinal adjustment in the direction of the damping device, one of these further components abuts the corresponding axial stop before the damping device can disengage. The abutment is therefore used as an additional holding force.

According to a conceivable further development of the assembly according to the invention, the elastomer body can have an at least half-side bellows contour and/or can form a fold and/or can be U-shaped when viewed in longitudinal section. Therefore, seen in longitudinal section, the elastomer body can have a first leg, which can be connected to the inner sleeve, a second leg, which can surround the outer circumference of the first leg, and a fold connecting the two legs to each other. In the first leg, the inner sleeve can be vulcanized in cohesively. A spring capacity, especially in the longitudinal direction, is also made possible by the fold. In addition, this design enables very soft bearing characteristics.

According to a conceivable further development of the assembly according to the invention, the elastomer body, viewed in longitudinal section, can have a center line which is radially covered in the region of the fold by the circumferential flange or at least tangential to the projection of the circumferential flange in the direction of the central longitudinal axis. The center line can also extend only through the legs. This relationship between circumferential flange and fold is used to prevent disengagement, specifically in that the circumferential flange holds the fold in the direction of the central longitudinal axis and backs it up.

According to a conceivable further development of the assembly according to the invention, a (third) longitudinal distance between the fold and the circumferential flange can be at least 2 mm. The longitudinal distance can be between the attachment surface of the circumferential flange and/or the circumferential flange-facing surface of the fold. A smaller dimension would limit the damping functionality.

### BRIEF DESCRIPTION OF THE DRAWINGS

Further features, details and advantages of the invention can be gathered from the wording of the claims and also from the following description of exemplary embodiments with reference to the drawings, in which:

FIG. 1 shows a schematic perspective view of a first embodiment of a damping device according to aspects and teachings of the invention;

FIG. 2 shows a longitudinal sectional view of the damping device according to FIG. 1;

FIG. 3 shows a longitudinal sectional view of a second embodiment of a damping device; and

FIG. 4 shows a longitudinal sectional view of an assembly according to the invention with the damping device according to FIG. 1.

### DETAILED DESCRIPTION

In the figures, like or corresponding elements are each denoted by like reference signs and therefore, if not expedient, are not described anew. In order to avoid repetition, features that have already been described will not be described again, and such features are applicable to all elements with the same or mutually corresponding reference signs unless this is explicitly ruled out. The disclosures in the description as a whole are transferable analogously to identical parts with the same reference signs or the same component designations. It is also the case that the positional indications used in the description, such as for example above/top, below/bottom, lateral, etc., relate to the figure presently being described and illustrated and, in the case of the position being changed, are to be transferred analogously to the new position. Furthermore, it is also possible for individual features or combinations of features from the different exemplary embodiments shown and described to constitute independent or inventive solutions or solutions according to the invention.

A radial direction R extends starting from a central longitudinal axis A. A circumferential direction U extends around the central longitudinal axis A, and a transverse center plane Q is arranged in such a way that its normal vector lies on the central longitudinal axis A. A longitudinal direction L extends parallel to the central longitudinal axis A.

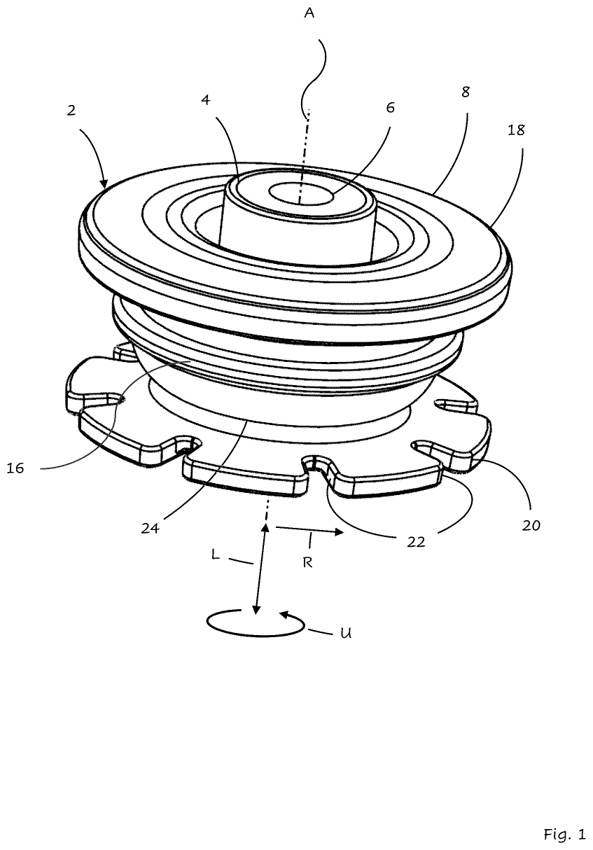

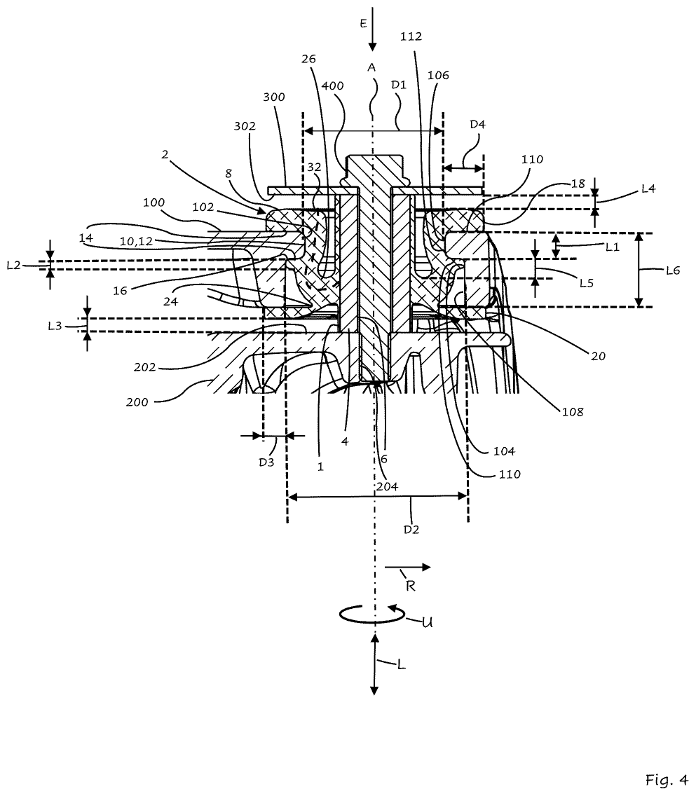

FIG. 1 shows a damping device 2 in the unloaded state, said damping device comprising an inner sleeve 4 which is provided, in the longitudinal direction L and/or in the direction of the central longitudinal axis A, with a through-hole or bore 6. The damping device 2 can be rotationally symmetrical with respect to the central longitudinal axis A. A fastening element 400 shown in FIG. 4, for example a screw, can be passed through the bore 6 in order to connect the damping device 2 to a component 200, 300. An elastomer body 8 is vulcanized onto the inner sleeve 4 and serves to fasten the damping device 2 to a first component 100. It can be seen that the damping device 2 is designed without an outer sleeve.

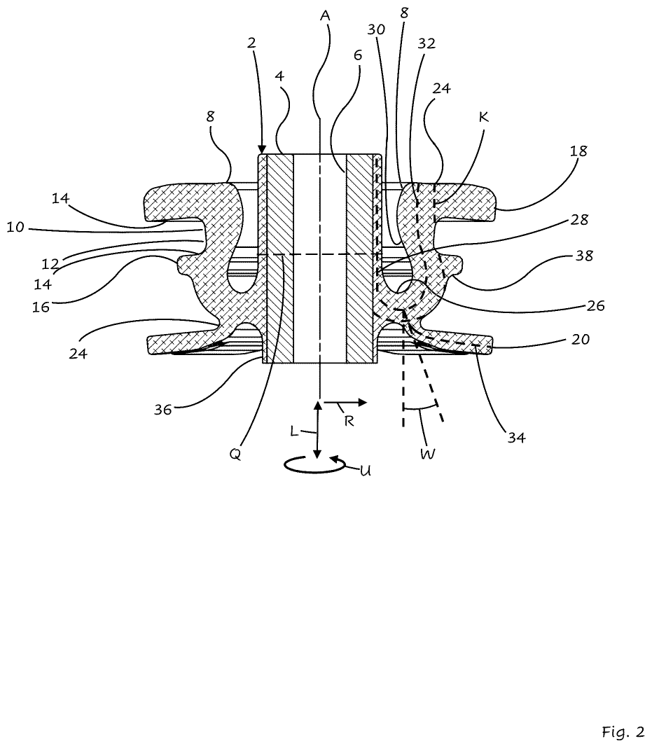

As can be seen also in conjunction with FIG. 2, the damping device 2 has a radially outwardly protruding axial stop 18, which can be an axial stop lying counter to an insertion direction E, and a radially outwardly protruding axial stop 20, which can be an axial stop lying in the insertion direction E. The axial stops 18, 20 are arranged on opposite end sides of the damping device 2 or of the elastomer body 8 and are circular in cross section. The axial stops 18, 20 are formed integrally with and of the same material as the elastomer body 8 and are connected to the second leg 30 at a respective connection point 24. It is shown in FIG. 1 in particular that the axial stop 20 has mounting slots 22 which extend in the radial direction R and are arranged equidistantly from each other with respect to the central longitudinal axis A.

FIG. 2 shows that the elastomer body 8 has a bellows contour K. The elastomer body 8 comprises a first leg 28, in which the inner sleeve 4 is integrally vulcanized, and a second leg 30, which surrounds the first leg 28 about the outer circumference. A fold 26, which describes a 1800 bend, connects the two legs 28, 30 to each other. It can also be seen that the elastomer body 8 has a center line 32, which extends centrally through the legs 28, 30 and the fold 26 of the elastomer body 8. The first leg 28 serves individually or together with the second leg 30 as a radial buffer or radial stop.

The axial stop 18 protrudes outward at a right angle from the second leg 30 in the radial direction R. The axial stop 20 has a center line 34. The center line 34 of the axial stop 20 meets the center line 32 of the elastomer body 8 in the region of the fold 26. At this point, the center line 34 of the axial stop 20 encloses with the central longitudinal axis A an angle W in the range of 0° to 45°. The axial stop 20 extends in its distal region in the radial direction R, optionally parallel to the axial stop 18.

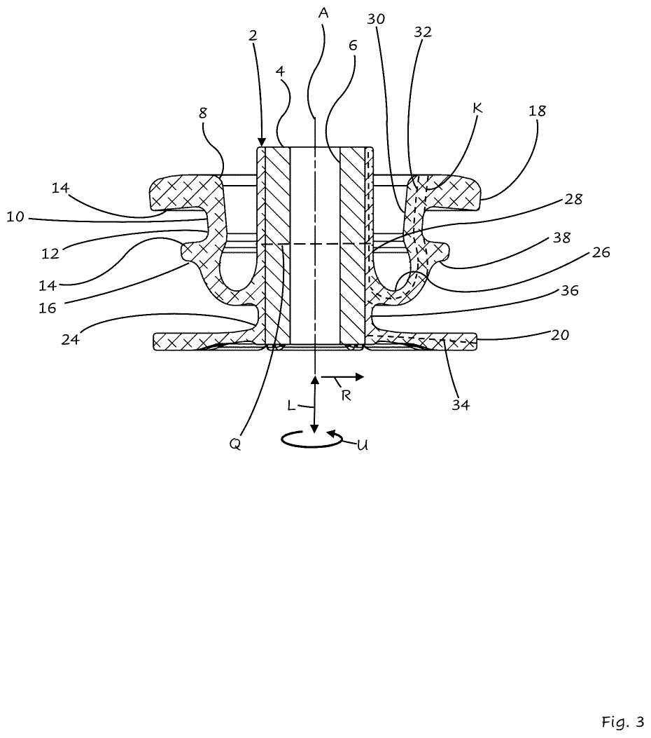

In the longitudinal direction L between the two axial stops 18, 20, the elastomer body 8 has, on the outer circumference, a circumferential projection 16 which protrudes outward in the radial direction R. It can be seen that the circumferential projection 16, in its unloaded state shown in FIGS. 2 and 3, has or has approximately a square or trapezoidal longitudinal sectional surface. The corners of the longitudinal sectional surface may be rounded for reasons relating to the production process. The circumferential projection 16 extends in its distal region in the radial direction R, optionally parallel to the axial stop 18, starting from the second leg 30. The circumferential projection 16 is integral with and of the same material as the elastomer body 8.

For fixing to the first component 100, the elastomer body 8 has an outward circumferential groove 10. The groove 10 is an outer circumferential groove and has a rectangular cross section.

In addition, the groove 10 has a groove base 12 and two groove walls 14 adjacent thereto, which groove walls are formed on the one hand by the axial stop 18 and on the other hand by the circumferential projection 16. A three-sided groove is therefore formed.

The inner sleeve 2 has a greater longitudinal extent than the elastomer body 8. The outer circumferential face of the inner sleeve 2 is completely covered with elastomer, this being due in part to the production process. Thus, the inner sleeve 2 is provided in an end region only with an elastomer skin 36, which is without function for the elastomer body 8 as such.

In order to avoid repetition, only the differences from FIG. 2 are described below with respect to FIG. 3. Whereas in the damping device according to FIG. 2, the axial stop 20 is formed integrally with and of the same material as the elastomer body 8 itself, the second axial stop 20 is now attached to the inner sleeve 2 adjacent to the elastomer body 8. Between this adjacent axial stop 20 and the elastomer body 8, an elastomer skin 36 is present on the inner sleeve 2, which elastomer skin results from the production process and is without function for the elastomer body 8 as such and for the adjacent axial stop 20 as such. In this embodiment, the adjacent axial stop 20 can be used as an absorption device for high-frequency vibrations. The adjacent axial stop 20 protrudes outward at a right angle from the inner sleeve 2 in the radial direction R.

FIG. 4 shows now an assembly 1 with the damping device 2 according to FIGS. 1 and 2, wherein here in principle the damping device 2 according to FIG. 3 can also be used.

In addition to the damping device 2, the assembly 1 comprises the first component 100, which can be a frame. The first component 100 has an opening 102, which is designed as a through-opening, such that the damping device 2 is connectable from both sides of the through-opening to a respective component 200, 300. The opening 102 has an inner circumferential surface 104, and the central longitudinal axis A runs through centrally. The damping device 2 is arranged in this opening 102, being inserted or pressed into the opening 102 in the direction of an insertion direction E. Thus, in the assembled state, a press fit is formed between damping device 2 and opening 102.

During assembly, the axial stop 20 is inserted into and guided through the opening 102 in the insertion direction E. After passing through the opening 102 or after being inserted sufficiently far into the opening 102, the axial stop 20 snaps out into its illustrated end position and rests against the first component 100.

The axial stop 20 and/or the circumferential projection 16 are/is designed in such a way that, upon mounting of the damping device 2 in the opening 102, the axial stop 20 bears on the elastomer body 8 axially below or adjacent to the circumferential projection 16. The length and/or the connection point 24 of the axial stop 20 can be dimensioned and/or arranged, for example, such that the axial stop 20 lies during assembly in a mounting corner 38, which can be formed from the circumferential projection 16. From the fold 26, the axial stop 20 also receives a pretensioning force, which contributes to the snap-open action. Seen in the longitudinal direction L, the radially inner connection point 24 of the axial stop 20 lies within the circumferential flange 106 or a first diameter D1.

The opening 102 has two mutually adjacent portions in the longitudinal direction L. On the one hand, a portion having the circumferential flange 106 and, on the other hand, a cylindrical attachment portion 108, which is arranged directly adjacent to the circumferential flange 106. The circumferential flange 106 protrudes inward in the radial direction R and engages positively in the groove 10. The circumferential flange 106 is surrounded on three sides. The circumferential flange 106 has at least one contact surface 110 for the groove 10, wherein the groove wall 14 bears thereon.

The groove 10 and the circumferential projection 16 each have a cross-sectionally circular outer circumferential contour, while the circumferential flange 106 and the attachment portion 108 of the opening 102 each have a cross-sectionally circular inner circumferential contour.

It is shown that, in the assembly state, the center line 32 runs such that it is radially overlapped in the region of the fold 26 by the circumferential flange 106 or at least tangent to the projection of the latter in the direction of the central longitudinal axis A. Purely for reasons of presentation, the center line 32 in the region of the first leg 28 is not depicted, even though present.

Further components 200, 300 are connected to the damping device 2, these being on the one hand a second component 200, which can be a compressor or a carrier of a compressor, and on the other hand a third component 300, which can be a stop plate. The components 200, 300 each have a stop surface 202, 302, which is in each case arranged axially adjacent to the corresponding axial stop 18, 20. The fastening element 400 engages through the third component 300, the inner sleeve 4, in order then to engage securely in a thread 204 in the second component 200.

A first longitudinal contact length L1, which extends in the longitudinal direction L, is formed along the groove base 12 of the groove 10 and the circumferential flange 106 or the radial inside face 112 thereof, wherein the first longitudinal contact length L1 indicates the distance over which the groove base 12 and the circumferential flange 106 bear with contact on each other. The first longitudinal contact length L1 can be in the range of 2 mm to 15 mm. A material thickness of the elastomer body 8 in the region surrounding the circumferential flange 106 corresponds at least in part to at least the first longitudinal contact length L1; in the present example, this applies to the axial stop 18 bearing on the circumferential flange 106 and to a region of the elastomer body 8 on the inner circumferential side of the circumferential flange 106.

A second longitudinal contact length L2, which extends in the longitudinal direction L, is formed between the elastomer body 8 or the circumferential projection 16 thereof and the inner circumferential surface 104 or the attachment portion 108. The second longitudinal contact length L2 indicates the distance over which the elastomer body 8 and the component 100 bear with contact on each other in the region outside the circumferential flange 106 or in the region of the attachment portion 108. The second longitudinal contact length L2 can be at least 1.5 mm. In the region of the second longitudinal contact length L2, the elastomer body 8, in the circumferential direction U, bears uninterrupted against the inner circumferential surface 104. The ratio between the second longitudinal contact length L2 and the first longitudinal contact length L1 can be greater than 0.75 (L2/L1>0.75).

A (first) longitudinal distance L3, which extends in the longitudinal direction L, can be present between the axial stop 20 and the stop surface 202. The (first) longitudinal distance L3 indicates the distance over which the axial stop 20 and the stop surface 202 can move relative to each other until they abut each other and the axial stop 20 buffers the abutment of the second component 200.

A (second) longitudinal distance L4, which extends in the longitudinal direction L, can be present between the axial stop 18 and the stop surface 302. The (second) longitudinal distance L4 indicates the distance over which the axial stop 18 and the stop surface 302 can move relative to each other until they abut each other and the axial stop 18 buffers the abutment of the third component 300.

A (third) longitudinal distance L5, which extends in the longitudinal direction L, can be present between the fold 26 and the circumferential flange 106 and can be at least 2 mm. The (third) longitudinal distance L5 indicates the distance between the fold 26 or its circumferential flange-facing surface, on the one hand, and the circumferential flange 106 or its fold-facing contact surface, on the other hand.

A length of the opening 102 in the longitudinal direction is designated by L6. A ratio of the length L6 of the opening 102 in the direction of the central longitudinal axis A to the second longitudinal contact length L2 can be in the range of 2 to 5.

A first diameter D1 is comprised by the circumferential flange 106 and indicates the clear width of the opening 102 in the region of the circumferential flange 106. A ratio of the diameter of the elastomer body 8 in the groove base 12 in the unloaded state of the elastomer body 8 to the diameter D1 of the circumferential flange 106 can be greater than 1.03.

A second diameter D2 is comprised by the attachment portion 108 and indicates the clear width of the opening 102 in the region of the attachment section 108, this being at the same time the largest diameter of the opening 102 in the example shown. A ratio of the diameter of the elastomer body 8 in the portion designed to bear on the inner circumferential surface 104, in particular in the region of the second longitudinal contact length L2, in the unloaded state of the elastomer body 8, to the diameter of the opening 102 in the region of the second longitudinal contact length L2 can be greater than 1.03. A difference between the second diameter D2 and the first diameter D1 can be greater than 5 mm.

The axial stop 20 bears at the front on the first component 100. The distance of this overlap is designated as the (first) overlap distance D3. The (first) longitudinal distance L3 can be smaller than this (first) overlap distance D3.

The axial stop 18 also bears at the front on the first component 100. The distance of this overlap is designated as the (second) overlap distance D4. The (second) longitudinal distance L4 can be smaller than this (second) overlap distance D4.

The invention is not restricted to any one of the embodiments described above and instead can be modified in a very wide variety of ways. All of the features and advantages apparent from the claims, the description and the drawing, including structural details, spatial arrangements and method steps, may be essential to the invention both individually and in a very wide variety of combinations.

The invention encompasses all combinations of at least two of the features disclosed in the description, the claims and/or the figures.

To avoid repetition, features disclosed in relation to a device are also considered, and can be claimed, to be disclosed in relation to a method. It is likewise the case that features disclosed in relation to a method are considered, and can be claimed, to be disclosed in relation to a device.

1. An assembly comprising:
a first component having an opening with an inner circumferential surface, and
a damping device having a central longitudinal axis, the damping device including an inner sleeve with a bore for fastening the damping device to a second component, and
an elastomer body for fastening the damping device to the first component,
wherein the elastomer body surrounds an outer circumference of the inner sleeve and supports itself in a pretensioned manner against the inner circumferential surface, and the damping device does not include an outer sleeve.

2. The assembly as claimed in claim 1, wherein the opening has a radially inwardly protruding circumferential flange, and the elastomer body has a circumferential groove, wherein the radially inwardly protruding circumferential flange engages positively in the circumferential groove, and wherein a first longitudinal contact length is formed along a groove base and the radially inwardly protruding circumferential flange.

3. The assembly as claimed in claim 1, wherein a ratio of a diameter of the elastomer body, at a portion configured to bear on a circumferential flange in an unloaded state of the elastomer body, to the diameter of the circumferential flange or to a largest diameter of the circumferential flange is greater than 1.03.

4. The assembly as claimed in claim 1, wherein a ratio of a diameter of the elastomer body, in a portion configured to bear on the inner circumferential surface, in a region of a second longitudinal contact length, in an unloaded state of the elastomer body, to the diameter of the opening or to a largest diameter of the opening is greater than 1.03.

5. The assembly as claimed in claim 1, wherein a difference between a second diameter and a first diameter is greater than 5 mm.

6. The assembly as claimed in claim 1, wherein a groove and/or a circumferential projection have/has a cross-sectionally circular, oval, elliptic or elongate outer circumferential contour, and/or
a circumferential flange and/or the inner circumferential surface and/or an attachment portion have/has a cross-sectionally circular inner circumferential contour.

7. The assembly as claimed in claim 1, wherein the damping device has at least one radially outwardly protruding axial stop.

8. The assembly as claimed in claim 7, wherein the at least one radially outwardly protruding axial stop has mounting slots that extend in a radial direction.

9. The assembly as claimed in claim 7, wherein the at least one radially outwardly protruding axial stop is disposed on the elastomer body, or, viewed in a longitudinal direction, is adjacent to the elastomer body.

10. The assembly as claimed in claim 7, wherein a second component, which is connectable to the damping device and has a stop surface, wherein a longitudinal distance between the at least one radially outwardly protruding axial stop and the stop surface is less than or equal to an overlap distance between this the at least one radially outwardly protruding axial stop and the first component.

11. The assembly as claimed in claim 7, wherein the at least one radially outwardly protruding axial stop is disposed at an end side of the damping device.

12. The assembly as claimed in claim 7, wherein the damping device has two radially outwardly protruding axial stops.

13. The assembly as claimed in claim 12, wherein the two radially outwardly protruding axial stops are disposed at opposite end sides of the damping device.

14. The assembly as claimed in claim 8, wherein the mounting slots are arranged equidistant from each other with respect to the central longitudinal axis.

15. The assembly as claimed in claim 7, wherein the at least one radially outwardly protruding axial stop is disposed on a fold of the elastomer body.

16. The assembly as claimed in claim 7, wherein the at least one radially outwardly protruding axial stop is, viewed in a longitudinal direction, adjacent to the elastomer body or a fold of the elastomer body.

17. The assembly as claimed in claim 10, wherein the second component is arranged axially adjacent to the at least one radially outwardly protruding axial stop.
